(19) United States
(12) Patent Application Publication
(10) Pub. No.: US 2011/0181921 A1
(43) Pub. Date: Jul. 28, 2011

(54) IMAGE READING APPARATUS AND IMAGE FORMING APPARATUS INCUDING THE SAME

(76) Inventors: Shohichi FUKUTOME, Osaka (JP); Mitsuharu Yoshimoto, Osaka (JP); Hironori Ogasawara, Osaka (JP); Kenji Nakanishi, Osaka (JP); Masahiro Imoto, Osaka (JP)

(21) Appl. No.: 12/987,385

(22) Filed: Jan. 10, 2011

(30) Foreign Application Priority Data
Jan. 28, 2010 (JP) 2010-016206

(51) Int. Cl. H04N 1/04

(52) U.S. Cl. 358/474

(57) ABSTRACT

An image reading apparatus of the present invention includes a photoelectric transducer that performs reading scanning along a main scanning line and reads an original, the image reading apparatus obtaining a white shading level of pixels based on an output level of the photoelectric transducer obtained when a reference white is read, obtaining a black shading level of the pixels based on an output level of the photoelectric transducer obtained when a black reference is read or obtained in a dark condition, and correcting the output level of the photoelectric transducer obtained when an original image is read with the use of the white shading level and the black shading level, and the image reading apparatus further comprising a correction unit that obtains a variation amount of the white shading level between a pixel and other pixels in the vicinity of that pixel for each of pixels on the main scanning line, determines whether the variation amount exceeds a pre-set threshold value, and when the correction unit determines that the variation amount exceeds the threshold value, corrects the black shading level of the pixel subject to that determination to increase the black shading level.

### CROSS-REFERENCE TO RELATED APPLICATIONS

This application claims priority under 35 U.S.C. §119(a) on Patent Application No. 2010-016206 filed in Japan on Jan. 28, 2010, the entire contents of which are herein incorporated by reference.

### BACKGROUND OF THE INVENTION

The present invention relates to image reading apparatuses that expose an original image to read the same, and image forming apparatuses including such an image reading apparatus.

This type of image reading apparatus reads an original by scanning the original in a main scanning direction with a photoelectric transducer, while transporting the original in a sub-scanning direction. Alternatively, the image reading apparatus reads an original by placing the original on a glass platen, and scanning the original in the sub-scanning direction and the main scanning direction with an optical scanning system and the photoelectric transducer arranged below the glass platen. Examples of the photoelectric transducer include a CCD (Charge Coupled Device).

Also, shading correction is performed on the output level of the photoelectric transducer obtained when an original is read in order to correct uneven illumination of the original or variation in sensitivity of the photoelectric transducer. For example, JP 2002-314805A (hereinafter referred to as “Patent Document 1”) discloses a technique in which a reference white plate is read by the photoelectric transducer to obtain a white shading level, and also a reference black plate is read by the photoelectric transducer to obtain a black shading level, the output level of the photoelectric transducer obtained when the original is read is corrected with the use of the white shading level and the black shading level, and thus effects of uneven illumination of the original or variation in sensitivity of the photoelectric transducer are removed. Note that the black shading level can be obtained also by performing reading by the photoelectric transducer with illumination turned off.

Incidentally, the photoelectric transducer repeatedly scans the original image in the main scanning direction (along the main scanning line) along with sub-scanning of the original image. If dust or the like is present on an optical path extending from the photoelectric transducer to the main scanning line, the photoelectric transducer reads the dust together with the original image, and the dust shows up as a streak in the sub-scanning direction in the read original image. For example, as shown in FIG. 8, in a configuration in which while an original is transported in a sub-scanning direction through a gap between a reference white plate 201 and a reading glass 202, the original is illuminated by a light source 203 above the reading glass 202 to read the original image by the photoelectric transducer 204 above the reading glass 202, when dust 206 is present on an optical path 205 extending from the photoelectric transducer 204 to the main scanning line, the dust 206 shows up as a streak in the sub-scanning direction in the read original image. In particular, when the original image is black and the dust 206 is white, a white streak shows up in a black or dark-tone original image 207, as shown in FIG. 9, significantly deteriorating image quality.

If dust adheres in a location that can be readily cleaned, it is possible to clean that location to remove the dust. However, if dust adheres to a location that cannot be readily cleaned, it is impossible to remove the dust. Then, it is necessary for a service person or the like to disassemble and clean the apparatus, and a streak keeps showing up in the read original image until the dust is removed. For example, in FIG. 8, even if dust adheres to the lower surface of the reading glass 202, the dust can be removed by cleaning that lower surface. However, if dust adheres to the upper surface of the reading glass 202, the apparatus needs to be disassembled for cleaning, and a streak keeps showing up in the original image until a service person or the like disassembles and cleans the apparatus.

### SUMMARY OF THE INVENTION

The present invention has been achieved in consideration of the above-described conventional issues, and aims at providing an image reading apparatus capable of, even if dust is present on the optical path extending from the photoelectric transducer to the main scanning line, significantly reducing the effect of the dust on the read original image, and an image forming apparatus including such an image reading apparatus.

In order to address the above-described issues, an image reading apparatus of the present invention includes a photoelectric transducer that performs reading scanning along a main scanning line and reads an original, the image reading apparatus obtaining a white shading level of pixels based on an output level of the photoelectric transducer obtained when a reference white is read, obtaining a black shading level of the pixels based on an output level of the photoelectric transducer obtained when a black reference is read or obtained in a dark condition, and correcting the output level of the photoelectric transducer obtained when an original image is read with the use of the white shading level and the black shading level, and the image reading apparatus further including a correction unit that obtains a variation amount of the white shading level between a pixel and other pixels in the vicinity of that pixel for each of pixels on the main scanning line, determines whether the variation amount exceeds a pre-set threshold value, and when the correction unit determines that the variation amount exceeds the threshold value, corrects the black shading level of the pixel subject to that determination to increase the black shading level.

With such an image reading apparatus of the present invention, the white shading level is obtained based on the output level of the photoelectric transducer obtained when a white reference is read, and obtains the black shading level based on the output level of the photoelectric transducer obtained when a black reference is read or obtained in a dark condition. When the white shading level of at least one pixel on the main scanning line overlapping dust varies due to the dust blocking the main scanning line and the variation amount exceeds the threshold value, the black shading level of the blocked pixel is corrected to be increased. When the tone of the blocked pixel on the main scanning line in the read original image is corrected with the use of the white shading level and the black shading level, the tone of that pixel becomes dark. Therefore, the streak caused by that pixel becomes dark and is not pronounced in a black or dark-tone original image.

With the image reading apparatus of the present invention, when the correction unit determines the variation amount of the white shading level exceeds the threshold value, regardless of whether the white shading level has risen or dropped, the correction unit may correct the black shading level of the pixel subject to that determination to increase the black shading level.

Since the image reading apparatus reads an original image, there are many white dust particles such as paper powder occurring from an original paper. When the white dust blocks the main scanning line, a white streak shows up in the original image. The light regularly reflected by the dust enters the photoelectric transducer or the shadow of the dust is read by the photoelectric transducer, so even if the dust is white, although it is impossible to identify whether the white shading level has risen or dropped, the white dust regardless shows up in the original image as a white streak. For this reason, the correction unit, whether the white shading level has risen or dropped, corrects the black shading level when the variation amount exceeds the threshold value.

Furthermore, with an image reading apparatus of the present invention, it is preferable that the correction unit increases a correction amount of the black shading level as the variation amount of the white shading level increases.

Specifically, the correction unit increases the correction amount of the black shading level as the tone of the pixel on the main scanning line overlapping the dust becomes lighter or darker. In this manner, a streak caused by the pixel in the original image can be effectively made less pronounced.

In this case, it is preferable that the correction unit sets an increase ratio of a correction amount of the black shading level relative to the variation amount of the white shading level to be greater when the white shading level rises so that the variation amount exceeds the threshold value than when the white shading level drops so that the variation amount exceeds the threshold value.

As described above, even with white dust, it is impossible to identify whether the white shading level rises or drops. However, since the streak in the original image is more pronounced when the white shading level rises than when the white shading level drops, by setting the increase ratio of the correction amount of the black shading level relative to the variation amount of the white shading level to be greater when the white shading level rises than when the white shading level drops, the streak in the original image can be made less pronounced.

Also with the image reading apparatus of the present invention, when pixels for which the correction unit determines that the variation amount of the white shading level exceeds the threshold value are successive pixels, the correction unit may count the number of the successive pixels, and in the case where the number of the successive pixels exceeds a fixed number, the black shading level of the successive pixels may be left uncorrected.

The variation in the white shading level due to dust or the like blocking the main scanning line often occurs in a range of one to several pixels, and rarely occurs in a range covering a large number of successive pixels. For this reason, it can be judged that the variation in the white shading level of such successive pixels is not due to the dust, and therefore correction of the black shading level thereof is unnecessary.

The image forming apparatus of the present invention includes the image reading apparatus of the present invention, and therefore has the same effect as the image reading apparatus of the present invention.

### BRIEF DESCRIPTION OF THE DRAWINGS

FIG. 1 is a cross-sectional view of an image forming apparatus to which an embodiment of an image reading apparatus of the present invention is applied.

FIG. 2 is a cross-sectional view of an image reading apparatus according to an embodiment of the present invention.

FIG. 3 is an enlarged cross-sectional view of the vicinity of a reading glass of a second reading unit in the image reading apparatus shown in FIG. 2.

FIG. 4 is block diagram showing the configuration of the second reading unit in the image reading apparatus shown in FIG. 2.

FIG. 5 is a graph showing characteristics lines W and B indicating a white shading level and a black shading level, respectively.

FIG. 6 is a flowchart of a procedure for setting the black shading level in a black shading memory based on the white shading level in a white shading memory.

FIG. 7 is a graph showing the relation between the level (tone) of a pixel subjected to shading correction and the level (tone) of a pixel read by a CCD.

FIG. 8 is a cross-sectional view conceptually showing a part of a conventional image reading apparatus.

FIG. 9 is a diagram showing a white streak showing up on a black or dark-tone original image.

### DESCRIPTION OF THE PREFERRED EMBODIMENTS

Embodiments of the present invention will be described in detail below with reference to the attached drawings.

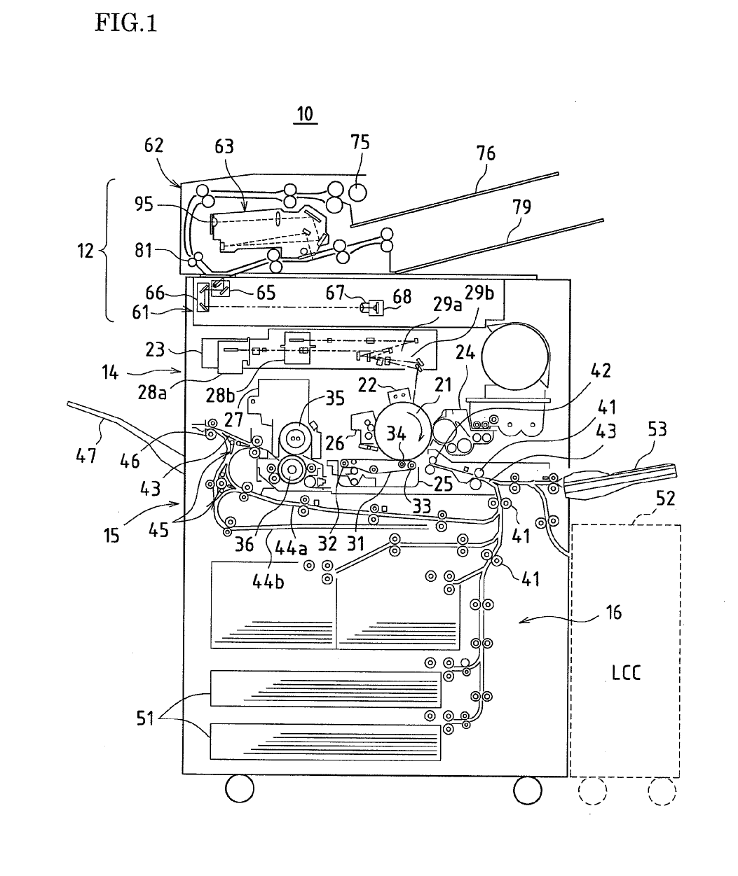

FIG. 1 is a cross-sectional view of an image forming apparatus to which an embodiment of an image reading apparatus of the present invention is applied. An image forming apparatus 10 obtains image data by reading an original image or from an outside source, and forms a monochrome image indicated by the obtained image data on a recording sheet. The image forming apparatus 10 is generally configured by an image reading apparatus 12, a image forming unit 14, a recording sheet transporting unit 15 and a paper feeding unit 16.

The image forming unit 14 records an original image represented by the image data on a sheet, and includes a photosensitive drum 21, a charging device 22, an optical writing unit 23, a developing device 24, a transfer unit 25, a cleaning unit 26, and a fixing device 27.

The photosensitive drum 21 has a photosensitive layer on the surface thereof. The photosensitive drum 21 is rotated in one direction while its surface is cleaned by the cleaning unit 26, and then the surface is evenly charged by the charging device 22. The charging device 22 may be a charger type, or a roller type or brush type, which contacts the photosensitive drum 21.

The optical writing unit 23 is a laser scanning unit (LSU) that includes two laser irradiation units 28a and 28b, and two mirror groups 29a and 29b. The optical writing unit 23 receives input of image data, emits laser beams corresponding to the image data from the laser irradiation units 28a and 28b, respectively, and irradiates the photosensitive drum 21 with these laser beams through the mirror groups 29a and 29b to expose the evenly-charged surface of the photosensitive drum 21, thereby forming an electrostatic latent image on the surface of the photosensitive drum 21.

The optical writing unit 23 employs a two-beam scheme, which includes two laser irradiation units 28a and 28b, in order to support high-speed printing, and thereby reduces a burden caused by speeding up of the irradiation timing.

Note that as the optical writing unit 23, an EL (electro luminescence) writing head in which light-emitting elements are arrayed, or an LED (light-emitting diode) writing head can be used instead of the laser scanning unit.

The developing device 24 supplies toner to the surface of the photosensitive drum 21 to develop an electrostatic latent image, and forms a toner image on the surface of the photosensitive drum 21. The transfer unit 25 transfers the toner image on the surface of the photosensitive drum 21 onto a recording sheet transported by the recording sheet transporting unit 15. The fixing device 27 applies heat and pressure to the recording sheet, and fixes the toner image on the recording sheet. Then, the recording sheet is transported to a discharge tray 47 by the recording sheet transporting unit 15 to be discharged outside. The cleaning unit 26 removes and collects toner that remains on the surface of the photosensitive drum 21 after development and transfer.

Here, the transfer unit 25 includes a transfer belt 31, a drive roller 32, a driven roller 33 and an elastic conductive roller 34. The transfer belt 31 is stretched across the rollers 32 to 34 and rotated around the rollers 32 to 34. The transfer belt 31 has a predetermined resistance (for example, 1×10⁹ to 1×10¹³ Ω/cm), and transports the recording sheet placed on the surface thereof. The elastic conductive roller 34 is pressed against the surface of the photosensitive drum 21 through the transfer belt 31, and presses the recording sheet on the transfer belt 31 onto the surface of the photosensitive drum 21. An electrical field of a polarity opposite to that of the charge of the toner image on the surface of the photosensitive drum 21 is applied to the elastic conductive roller 34, and the toner image on the surface of the photosensitive drum 21 is transferred to the recording sheet on the transfer belt 31 due to the electrical field of the opposite polarity.

The fixing device 27 includes a heating roller 35 and a pressure roller 36 as fixing rollers. The heating roller 35 and the pressure roller 36 are pressed against each other, thereby forming a nip region between them. When a recording sheet is transported to this nip region, the unfixed toner image on the recording sheet is melted by heating and pressed while the recording sheet is transported by the rollers 35 and 36, so that the toner image is fixed onto the recording sheet.

The recording sheet transporting unit 15 includes a plurality of pairs of transporting rollers 41 for transporting the recording sheet, a pair of registration rollers 42, a transportation route 43, reverse transportation routes 44a and 44b, a plurality of branching claws 45, and a pair of discharge rollers 46.

In the transportation route 43, the recording sheet is received from the paper feeding unit 16, and transported until the leading end of the recording sheet reaches the registration rollers 42. At this time, since the registration rollers 42 are temporarily stopped, the leading end of the recording sheet abuts against the registration rollers 42, and the recording sheet is bent. The leading end of the recording sheet is aligned parallel to the registration rollers 42 due to elasticity of the bent recording sheet. Thereafter, the registration rollers 42 start rotating so that the recording sheet is transported to the transfer unit 25 of the image forming unit 14 by the registration rollers 42, transported to the discharge rollers 46 via the transfer unit 25 and the fixing device 27, and further transported to the discharge tray 47 by the discharge rollers 46.

In the case where an image is recorded on the back face of the recording sheet as well, the branching claws 45 are selectively switched so as to guide the recording sheet from the transportation route 43 to the reverse transportation route 44b, and temporarily stop transporting the recording sheet. The branching claws 45 are further selectively switched again so as to guide the recording sheet from the reverse transportation route 44b to the reverse transportation route 44a, and the front and back faces of the recording sheet are inverted. Then, the recording sheet is transported back to the registration rollers 42 of the transportation route 43 through the reverse transportation route 44a.

Such transportation of the recording sheet is called switchback transportation, and the front and back faces of the recording sheet are inverted by the switchback transportation, with the leading end and the trailing end of the recording sheet being inverted at the same time. Accordingly, when the recording sheet is inverted and is returned to the registration rollers 42, the trailing end of the recording sheet abuts against the registration rollers 42, and the trailing edge of the recording sheet is aligned parallel to the registration rollers 42. The recording sheet is transported to the transfer unit 25 of the image forming unit 14 from the trailing end thereof by the registration rollers 42, printing is performed on the back face of the recording sheet, and an unfixed toner image on the back face of the recording sheet is melted by heating and pressed by the rollers 35 and 36 of the fixing device 27 to fix the toner image to the back face of the recording sheet. Thereafter, the recording sheet is transported to the discharge tray 47 by the discharge rollers 46.

The paper feeding unit 16 includes a plurality of paper feed trays 51.

The paper feed trays 51 are for storing recording sheets, and arranged in a lower portion of the image forming apparatus 10. Each paper feed tray 51 also includes a pickup roller for drawing in recording sheets one by one, and feeds a drawn-in recording sheet to the transportation route 43 of the recording sheet transporting unit 15.

Also in a side face of the image forming apparatus 10, a large capacity cassette (LCC) 52 capable of stocking a large number of recording sheets of a plurality of types and a manual feed tray 53 for supplying a recording sheet of non-standard size are provided.

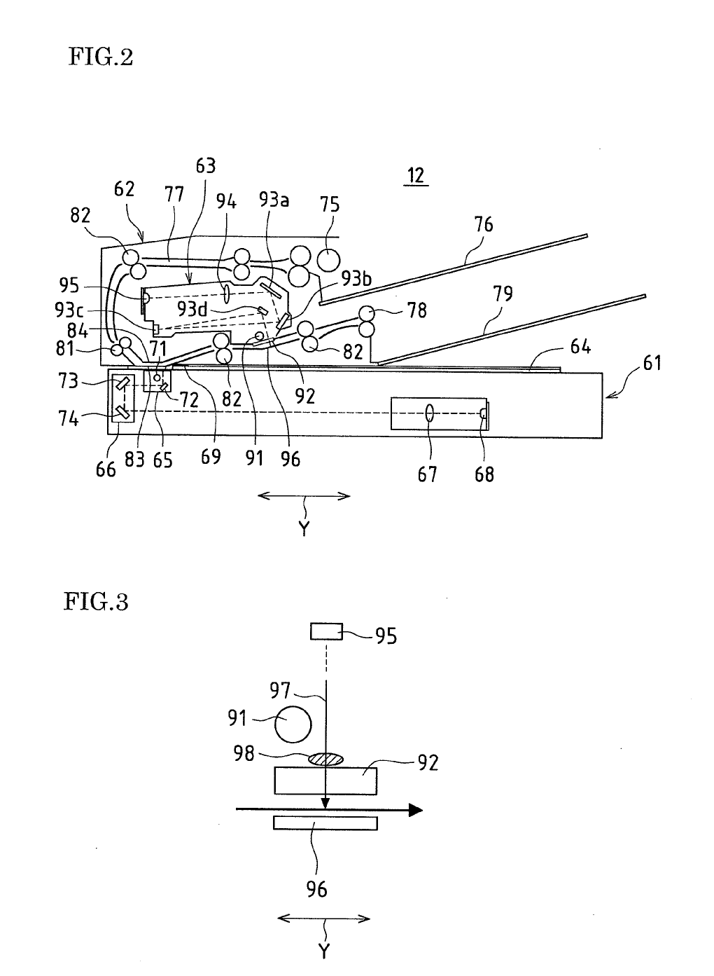

Next, with reference to FIG. 2, the image reading apparatus 12 according to the present embodiment mounted in an upper portion of the main body of the image forming apparatus 10 shown in FIG. 1 will be described. FIG. 2 is an enlarged cross-sectional view of an image reading apparatus 12.

The image reading apparatus 12 according to the present embodiment includes a first reading unit 61 on the lower side, an automatic feed cassette (ADF) 62 on the upper side, and a second reading unit 63 incorporated in the ADF 62.

The rear side of the ADF 62 on the upper side is pivotably supported by the rear side of the first reading unit 61 on the lower side by a hinge (not shown), and the front portion of the ADF 62 is opened/closed by lifting the front portion up and down. When the ADF 62 is opened, a glass platen 64 of the first reading unit 61 on the lower side is opened, and an original is placed on the glass platen 64.

The first reading unit 61 includes the glass platen 64, a first scanning unit 65, a second scanning unit 66, an imaging lens 67, a CCD (Charge Coupled Device) 68, and a reference white plate 69. The first scanning unit 65 includes a light source 71 and a first reflecting mirror 72. The first scanning unit 65 illuminates the original on the glass platen 64 by the light source 71 while moving in the sub-scanning direction Y by a distance corresponding to the original size at a constant speed V, and reflects the light reflected by the original by the first reflecting mirror 72 to guide the reflected light to the second scanning unit 66, thereby scanning the image on the original surface in the sub-scanning direction. The second scanning unit 66 includes second and third reflecting mirrors 73 and 74. The second scanning unit 66 moves at a speed V/2 while following the first scanning unit 65, and reflects the light reflected by the original by the second and third reflecting mirrors 73 and 74 to guide the reflected light to the imaging lens 67. The imaging lens 67 collects the reflected light from the original on the CCD 68 and forms an image on the original surface on the CCD 68. The CCD 68 repeatedly scans the original image in the main scanning direction (direction perpendicular to the sub-scanning direction Y), and at each instance of scanning, outputs an analog image signal of one main scanning line.

The first reading unit 61 in the lower side can read not only a still original, but also an image on the surface of the original transported by the ADF 62. In this case, the first scanning unit 65 is moved to the reading position that is below an original reading glass 83, and positions the second scanning unit 66 depending on the position of the first scanning unit 65, and in this state, transportation of the original by the ADF 62 is started.

In the ADF 62, a pickup roller 75 is pressed against the original on an original tray 76 and rotated so as to draw in an original, and then transports the original through an original transport path 77. Registration rollers 81 for aligning the leading end of the original before transporting the original and transporting rollers 82 for transporting the original are arranged along the original transport path 77. The original passes between the original reading glass 83 of the first reading unit 61 and a reading guide plate 84, and further is transported from discharge rollers 78 to a discharge tray 79.

When the original is transported as described above, the original surface is illuminated by the light source 71 of the first scanning unit 65 through the original reading glass 83, the reflected light from the original surface is guided to the imaging lens 67 by the reflecting mirrors of the first and second scanning units 65 and 66, and the reflected light from the original surface is collected by the imaging lens 67 onto the CCD 68 so as to form an original image on the CCD 68. As a result, the original image is read by the CCD 68.

Also, while reading the image on the surface of the original transported by the ADF 62, the image on the back face of the original can be simultaneously read by the second reading unit 63 incorporated in the ADF 62. The second reading unit 63 is disposed above the glass platen 64, and includes a light source 91, a reading glass 92, first to fourth reflecting mirrors 93a to 93d, an imaging lens 94, a CCD (Charge Coupled Device) 95, and a reference white plate 96.

A gap is formed between the reading glass 92 and the reference white plate 96, and the original is transported passing over the original reading glass 83, passes through the gap between the reading glass 92 and the reference white plate 96, and is further transported from the discharge rollers 78 to the discharge tray 79.

When the original is transported in the sub-scanning direction through the gap between the reading glass 92 and the reference white plate 96, the back face of the original below the reading glass 92 is illuminated by the light source 91, and the light reflected by the back face of the original is reflected by the first to fourth reflecting mirrors 93a to 93d and guided to the imaging lens 94. The imaging lens 94 collects the reflected light from the original on the CCD 95 so as to form the image on the back face of the original on the CCD 95. The CCD 95 repeatedly scans the original image in the main scanning direction (direction perpendicular to the sub-scanning direction Y), and at each instance of scanning, outputs an analog image signal of one main scanning line.

In this manner, the original image read by the CCDs 68 and 95 of the first and second reading units 61 and 63 is output as analog image signals from the CCDs 68 and 95, and the analog image signals are A/D converted to digital image data. The image data is transmitted to the laser exposing device 23 of the image forming apparatus 10 after undergoing various types of image processing, and the image is recorded on the recording sheet in the image forming apparatus 10. This recording sheet is output as a duplicate of the original.

As shown in FIG. 3, in the second reading unit 63, if dust 98 is present on an optical path 97 extending from the CCD 95 to the main scanning line (original reading position) below the reading glass 92, the dust 98 is repeatedly scanned in the main scanning direction with the original image by the CCD 95, with a streak in the sub-scanning direction showing up in the read original image due to the dust 98. In particular, in the case where the original image is black and the dust 98 is white, a white streak shows up in a black or dark-tone original image 207 as shown in FIG. 9, which significantly deteriorates image quality.

Also, in the case where the dust 98 adheres to the upper surface of the reading glass 92, the apparatus needs to be disassembled for cleaning, and reading of the original has to be performed in a state that a streak shows up in the original image, until a service person or the like disassembles and cleans the apparatus.

In view of this, in the image reading apparatus 12 of the present embodiment, when the white shading level and the black shading level used for performing shading correction of the uneven illumination of the original or variation in sensitivity of the CCD 95 are obtained, when the white shading level of at least one pixel on the main scanning line that is blocked by the dust varies and the amount of such variation exceeds a threshold value, the black shading level of that pixel is corrected to be increased. By performing shading correction on the image data representing the read original image using these white shading level and black shading level, a streak in the read original image can be effectively suppressed.

Dust on the surface of the glass platen 64 and the original reading glass 83 can be readily removed if cleaned by the user. The dust on the front and back faces of the glass platen 64 are hardly pronounced since the dust shows up as a spot in the read original image. Furthermore, it is possible to avoid reading the dust on the front and back faces of the original reading glass 83 by changing the position of the first scanning unit 65 in the sub-scanning direction. On the contrary, the dust on the upper surface of the reading glass 92 of second reading unit 63 cannot be readily removed, is pronounced on the read original image as a result of showing up as a streak, and in addition it is impossible to avoid reading the dust. Therefore, the correction of the black shading level according to the present embodiment is effective.

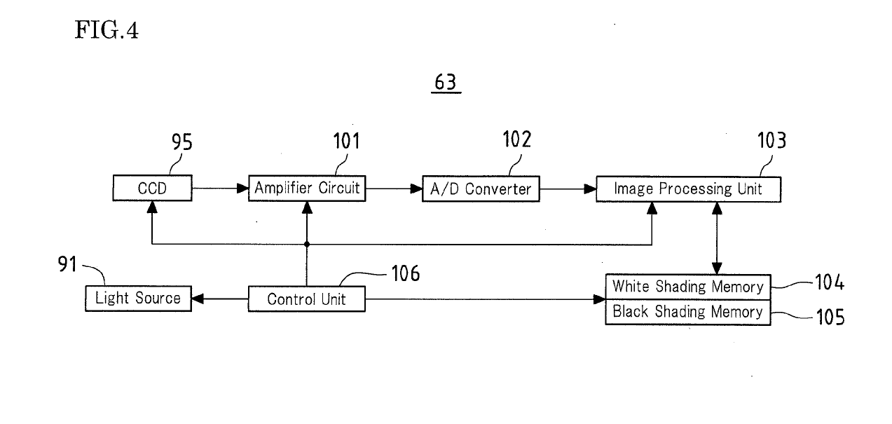

FIG. 4 is a block diagram showing the configuration of the second reading unit 63 for performing shading correction. As shown in FIG. 4, the second reading unit 63 includes the light source 91, the CCD 95, an amplifier circuit 101 capable of gain control and that amplifies analog image signals output from the CCD 95, an A/D converter 102 that receives input of analog image signals from the amplifier circuit 101 to convert the signals into digital image data, an image processing unit 103 that receives image data from the A/D converter 102 and subjects the image data to various types of image processing such as shading correction, a white shading memory 104 and a black shading memory 105 that respectively store the white shading level and the black shading level, and a control unit 106 that generally controls the second reading unit 63 and corrects the black shading level. Note that the control unit 106 may control the first reading unit 61 or the image reading apparatus 12, in addition to the second reading unit 63.

In the second reading unit 63 as configured above, the control unit 106, in a condition in which reading of the original is not performed, for example when the image forming apparatus 10 is started up, turns on the light source 91 to cause the light of the light source 91 to enter the reference white plate 96 through the reading glass 92 and illuminates the reference white plate 96, thereby causing the CCD 95 to read the reference white plate 96 in the main scanning direction (along the main scanning line). At this time, analog image signals representing the tones of the pixels on the main scanning line are output from the CCD 95, and these analog image signals are amplified in the amplifier circuit 101 and converted to image data in the A/D converter 102. The image data is stored in the white shading memory 104 as a white shading level through the image processing unit 103. Accordingly, the white shading level represents the tones of the pixels on the main scanning line obtained when the CCD 95 reads the reference white plate 96.

Also, the control unit 106 turn off the light source 91 to cause the CCD 95 to perform reading in the main scanning direction, in a condition in which light does not enter the CCD 95. At this time, analog image signals output from the CCD 95 are converted to image data by the A/D converter 102, as a result of being amplified in the amplifier circuit 101. The image data is stored in the black shading memory 105 as the black shading level through the image processing unit 103. Accordingly, the black shading level represents the tones of the pixels on the main scanning line obtained when the CCD 95 in a dark condition performs reading in the main scanning direction.

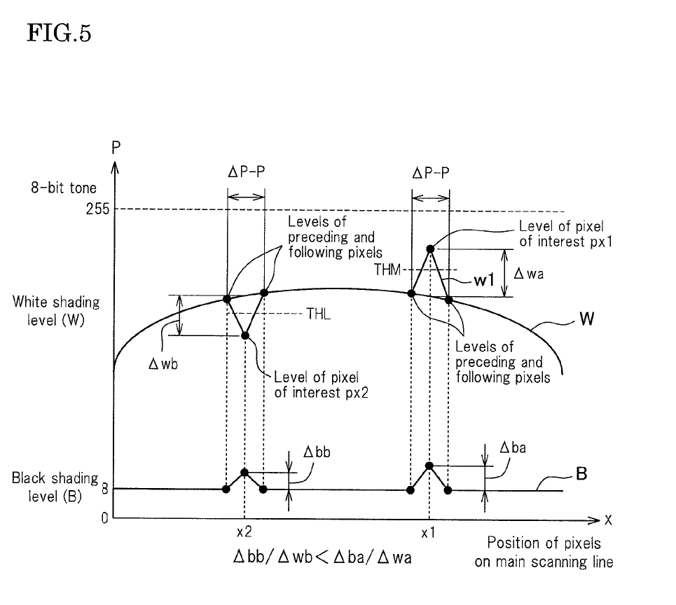

FIG. 5 is a graph showing characteristics lines W and B respectively indicating the white shading level and the black shading level. In the graph in FIG. 5, the horizontal axis marks the position x of the pixels on the main scanning line, while the vertical axis marks the shading level (tone) P. The tone “255” corresponds to white, and the tone “0” corresponds to black.

As shown in the graph in FIG. 5, the characteristics line W representing the white shading level generally has the form of gentle curve, having a tone characteristic of falling at both ends of the main scanning line and rising at the center of the main scanning line. The characteristics line B representing the black shading level generally has the form of a straight line, showing a uniform tone characteristic. The tone of the pixels on the main scanning line represented by the characteristics line W of the white shading level is stored in the white shading memory 104, while the tone of the pixels on the main scanning line represented by the characteristics line B of the black shading level is stored in the black shading memory 105.

Here, the black shading level represents the tone of the pixels on the main scanning line obtained when the CCD 95 performs reading in the main scanning direction in a dark condition, and therefore, the black shading level has a uniform tone characteristic regardless of the presence of dust blocking the main scanning line.

On the other hand, the white shading level represents the tone of the pixels on the main scanning line obtained when the CCD 95 reads the reference white plate 96 while the reference white plate 96 is illuminated, and therefore when dust blocking the main scanning line is present, the tone of the pixels on the main scanning line varies due to the dust. For example, as shown in FIG. 3, when the dust 98 adheres to the upper surface of the reading glass 92, and the dust 98 is present in the optical path 97 extending from the CCD 95 to the main scanning line below the reading glass 92, the dust is read by the CCD 95 and the tone of the pixel on the main scanning line overlapping the dust 98 varies.

Since the image reading apparatus 12 reads an original image, there are many white dust particles such as paper powder occurring from the original paper. When the white dust adheres to the upper surface of the reading glass 92 and blocks the main scanning line, the CCD 95 repeatedly scans the dust in the main scanning direction with the original image and the dust shows up as a white streak on the read original image.

When light regularly reflected by the dust enters the CCD 95, the white shading level of the pixel at the position of the dust increases irregularly. In the graph shown in FIG. 5, there is a position x1 where the characteristics line W protrudes in the form of a sharp peak and the white shading level irregularly rises. The dust overlaps the pixel at the position x1.

If a black or dark-tone original image that has been read is subjected to shading correction without correcting the black shading level as conventionally, the dust clearly shows up as a white streak on the original image.

In addition, since the dust generates a shadow depending on the incident direction of the light from the light source 91 to the dust, the white shading level of the pixel at the position of the dust may be irregularly low. However, since the dust is white dust such as paper powder, the white shading level does not fall to the black tone, but to a gray tone. In the graph shown in FIG. 5, there is a position x2 where the characteristics line W dips in the form of a sharp valley and the white shading level irregularly drops. The dust overlaps the pixel at the position x2.

In this case as well, if a black or a dark-tone original image that has been read is subjected to shading correction without correcting the black shading level as conventionally, the dust shows up as a white streak on the original image.

For this reason, as described above, when white shading level of at least one pixel on the main scanning line that is blocked by the dust varies and the amount of such variation exceeds a threshold value, the black shading level of that pixel is corrected to be increased, and the streak in the original image is effectively suppressed by the shading correction on the image data of the read original image.

The control unit 106, in order to perform such black shading level correction, references the white shading level in the white shading memory 104 and extracts the pixel at the position where the white shading level irregularly rises. Then, the control unit 106 references the black shading level in the black shading memory 105 to correct the black shading level of the extracted pixel to increase the level, and updates the black shading level of the extracted pixel in the black shading memory 105. As shown in the graph in FIG. 5, the black shading level of the characteristics line B that corresponds to the pixel at the position x1 where the characteristics line W protrudes in the form of a sharp peak is corrected to be increased, and the black shading level of the characteristics line B that corresponds to the pixel at the position x2 where the characteristics line W dips in the form of a sharp valley is corrected to be increased.

Specifically, the control unit 106 references the white shading level of the pixels on the main scanning line in the white shading memory 104 and sequentially focuses on each pixel as a pixel of interest, and averages, for each pixel of interest, the white shading levels corresponding to two pixels preceding and following the pixel of interest. The difference obtained by subtracting the average value from the white shading level of the pixel of interest is obtained, and when the difference is a positive value, the white shading level is determined to have risen, and the absolute value of the difference (a variation amount Δwa of the white shading level) is compared with a pre-set first threshold value THM. When the variation amount Δwa exceeds the first threshold value THM, the white shading level is determined to have irregularly risen. The control unit 106 obtains a correction amount Δba proportionate to the variation amount Δwa, references the black shading level in the black shading memory 105, corrects the black shading level of the pixel of interest px1 to increase the level by the correction amount Δba, and updates the black shading level of the pixel of interest px1 in the black shading memory 105 (see the graph in FIG. 5).

Also, the control unit 106 averages, for each pixel of interest, the white shading levels corresponding to two pixels preceding and following the pixel of interest, and obtains the difference by subtracting the average value from the white shading level of the pixel of interest. When the difference is a negative value, the control unit 106 determines that the white shading level to have dropped, and compares the absolute value of the difference (a variation amount Δwb of the white shading level) with a pre-set second threshold value THL. When the variation amount Δwb exceeds the second threshold value THL, the control unit 106 determines the white shading level to have irregularly dropped, obtains a correction amount Δbb proportionate to the variation amount Δwb, references the black shading level in the black shading memory 105, corrects the black shading level of the pixel of interest px2 to increase the level by the correction amount Δbb, and updates the black shading level of the pixel of interest px2 in the black shading memory 105 (see the graph in FIG. 5).

Also, the control unit 106 sets the increase ratio of the correction amount of the black shading level relative to the variation amount of the white shading level to be greater when the white shading level rises than when the white shading level drops. That is, while the black shading level of the pixel of interest is corrected so as to be increased in proportion to the variation amount of the white shading level of the pixel of interest, the proportionality factor (Δba/Δwa) applied when the white shading level rises is set greater than the proportionality factor (Δbb/Δwb) applied when the white shading level drops ((Δba/Δwa)>(Δbb/Δwb)).

However, the variation in the white shading level due to dust or the like blocking the main scanning line often occurs in a range of one to several pixels, and rarely occurs in a range covering a large number of successive pixels. Accordingly, when pixels for which the variation amount of the white shading level is determined to exceed the first threshold value THM or second threshold value THL are successive pixels and the number of such successive pixels exceeds a fixed value (Δp−p) (see the graph in FIG. 5), the control unit 106 determines that the variation in the white shading level is not due to the dust and does not correct the black shading level. Thus, unnecessary correction of the black shading level is avoided. For example, when the number of successive pixels for which the control unit 106 determines that the variation amount of the white shading level exceeds the first threshold value THM or second threshold value THL exceeds 20, ((Δp−p)), the black shading level is not corrected.

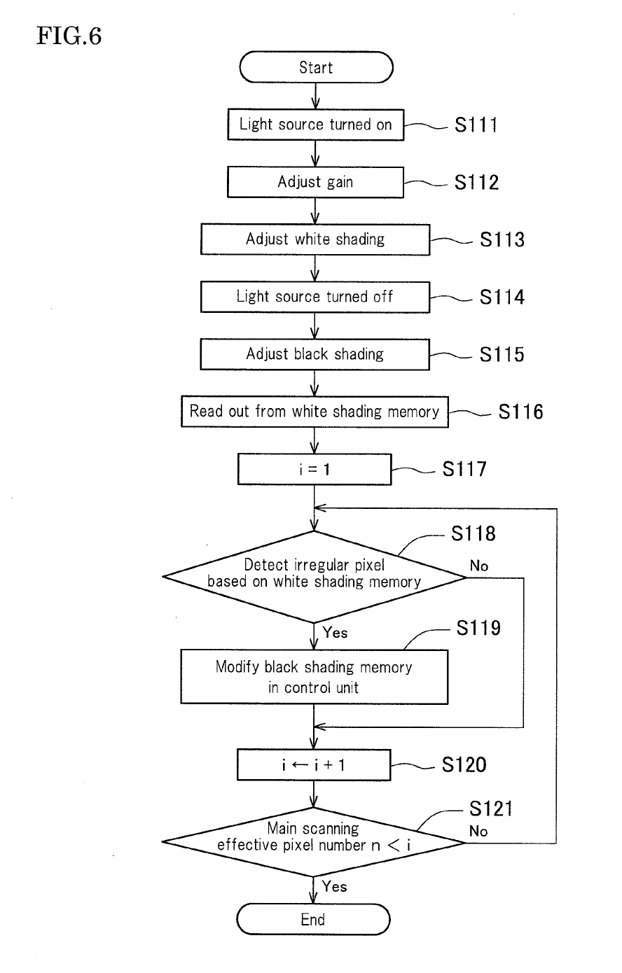

Next, the procedure for correcting the black shading level in the black shading memory 105 will be summarized and described with reference to the flowchart shown in FIG. 6.

Initially, the control unit 106 turns on the light source 91 (step S111), and causes the light of the light source 91 to enter the reference white plate 96 through the reading glass 92 so as to illuminate the reference white plate 96. The control unit 106 then causes the CCD 95 to read the reference white plate 96 along the main scanning line, and controls the gain of the amplifier circuit 101 so as to appropriately set the level of the analog image signals output from the CCD 95 (step S112). After adjusting the gain of the amplifier circuit 101, the control unit 106 causes the CCD 95 to read the reference white plate 96 again along the main scanning line. Analog image signals output from the CCD 95 are amplified by the amplifier circuit 101 and converted to digital image data by the A/D converter 102. The image data is stored in the white shading memory 104 as the white shading level through the image processing unit 103 (step S113).

Next, the control unit 106 turns off the light source 91 (step S114), and causes the CCD 95 to perform reading in the main scanning direction in a dark condition in which the light does not enter the CCD 95. At this time, analog image signals output from the CCD 95 are converted to image data by the A/D converter 102, and the image data is stored in the black shading memory 105 as the black shading level through the image processing unit 103 (step S115).

After storing the white shading level and the black shading level in the white shading memory 104 and the black shading memory 105, the control unit 106 references the white shading level in the white shading memory 104 (step S116), and initializes the order of pixel i to “1” (step S117). Then, the control unit 106 reads out three white shading levels corresponding to the pixel of the order i=1 and the two pixels preceding and following the same from the white shading memory 104, obtains the average value of the white shading levels of the two preceding and following pixels, and subtracts the average value from the white shading level of the order i=1 to obtain difference. When the difference is a positive value, the control unit 106 determines the white shading level to have risen, and compares the absolute value of the difference (the variation amount Δwa of the white shading level) with the first threshold value THM. When the variation amount Δwa exceeds the first threshold value THM, the control unit 106 determines the white shading level to have irregularly risen (Yes in step S118), obtains the correction amount Δba proportionate to the variation amount Δwa, references the black shading level in the black shading memory 105, corrects the black shading level of the pixel of the order i=1 to increase the level by correction amount Δba, and updates the black shading level of that pixel in the black shading memory 105 (step S119).

Alternately, when the difference is a negative value, the control unit 106 determines the white shading level to have dropped, and compares the absolute value of the difference (the variation amount Δwb of the white shading level) with the second threshold value THL. When the variation amount Δwb exceeds the second threshold value THL, the control unit 106 determines the white shading level to have irregularly dropped (Yes in step S118), obtains the correction amount Δbb proportionate to the variation amount Δwb, references the black shading level in the black shading memory 105, corrects the black shading level of the pixel of the order i=1 to increase the level by the correction amount Δbb, and updates the black shading level of that pixel in the black shading memory 105 (step S119).

When the variation amount of the white shading level exceeds neither the first threshold value THM nor the second threshold value THL (No in step S118), step S119 is omitted and the procedure proceeds to step S120.

Next, the control unit 106 increments the order i to “2” (step S120), and determines whether the order i after increment exceeds the number of all pixels n on the main scanning line to be read by CCD 95 (step S121), that is, determines whether the processing in steps S118 and S119 has finished on all the pixels on the main scanning line. When the processing has not finished on all the pixels on the main scanning line (No in step S121), the procedure returns to step S118, and when the processing has finished on all the pixels (Yes in step S121), the control unit 106 ends the processing in FIG. 6.

With respect to the first pixel (order i=1) and the nth pixel that is the last pixel, the first pixel is adjacent to the second pixel only and the nth pixel is adjacent to the (n-1)th pixel only, and therefore the white shading level of the second pixel and the (n-1)th pixel is set as the average value of the white shading levels of two adjacent pixels. With respect to the second to the (n-1)th pixels, the average value of the white shading levels of two pixels preceding and following the pixel of interest is obtained.

Also, when pixels for which the variation amount of the white shading level is determined to exceed the first threshold value THM or the second threshold value THL are successive pixels during processing in steps S118 and S119, the control unit 106 counts the number of such successive pixels. When the number of the successive pixels exceeds a fixed value, the control unit 106 determines that the variation in the white shading level at this time is not due to dust, and does not correct the black shading level. For example, the control unit 106 stores original black shading levels that are not corrected in the internal memory of the control unit 106, and when pixels for which the variation amount of the white shading level is determined to exceed the first threshold value THM or the second threshold value THL are successive pixels, the control unit 106 counts the number of such successive pixels. When the number of the successive pixels exceeds a fixed value (Δp−p), the control unit 106 determines that the variation in the white shading level at this time is not due to dust, and erases the corrected black shading level of the pixels in the black shading memory 105 and stores again in black shading memory 105 the black shading levels of the pixels before correction that are stored in the internal memory, thereby canceling correction of the black shading levels of the pixels.

In this manner, after the black shading level in the black shading memory 105 are corrected based on the white shading level in the white shading memory 104, the original image is read by the CCD 95, and the image data representing the original image is input to the image processing unit 103. The image processing unit 103 uses the white shading level in the white shading memory 104 and the black shading level in the black shading memory 105 to perform shading correction on image data. As a result of the shading correction, in addition to suppression of uneven illumination of the original and variation in sensitivity of the CCD 95, a streak in the original image is suppressed. In addition, other image processing is performed on the image data by the image processing unit 103, and the processed image data is output from the image processing unit 103 to the laser exposing device 23 of the image forming apparatus 10.

The image processing unit 103 performs shading correction on each pixel i on the main scanning line based on the following equation (1).

Pout=coefficient×(Pin·PB)/(PW·PB)+constant B (1)

In equation (1), Pout is the level (tone) of the pixel subjected to shading correction, Pin is a level (tone) of the pixel read by the CCD 95, PW is the white shading level of the pixel, PB is the black shading level of the pixel, and the coefficient and constant B are fixed values.

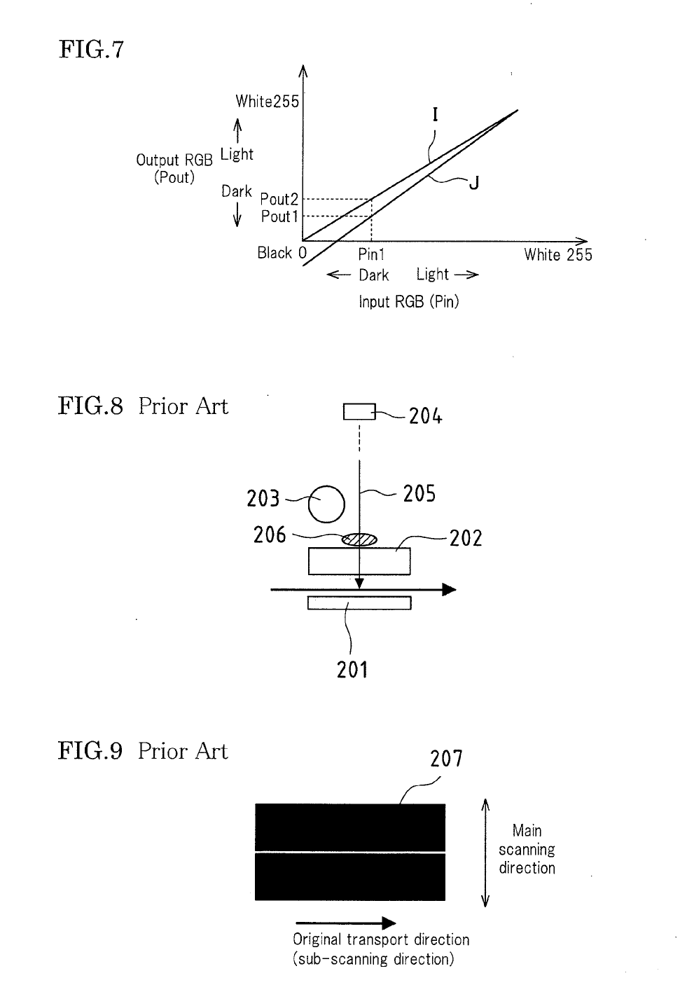

The graph in FIG. 7 shows the relation between Pin and Pout in the above equation (1). In the graph, the characteristics line I shows the relation between Pin and Pout when the black shading level is not corrected, while the characteristics line J shows the relation between Pin and Pout when the black shading level is corrected as in the present embodiment.

As understood clearly by comparing the characteristics lines I and J in the graph in FIG. 7, when the black shading level of the pixel blocked by dust is corrected as in the present embodiment, for example, the pixel level Pout1 corresponding to the pixel level Pin1 drops (drops from the tone on the characteristics line I to the tone on the characteristics line J), and the pixel (dust) on the read original image becomes dark. Also, since pixels around the blocked pixel are not blocked by dust and the black shading levels thereof are not corrected, the pixel level Pout2 (tone on the characteristics line I) corresponding to the pixel level PFin1 are maintained. Based on the above, it is understood that a streak caused by dust on a black or dark-tone original image that has been read becomes less pronounced.

As described above, correcting the black shading level to increase the level in proportion to the variation amount of the white shading level corresponds to increasing the tilt of the characteristics line J in response to the increase in the variation amount of the white shading level. Thus, the level of the pixel (dust) subjected to the shading correction is further lowered so as to make the pixel (dust) darker. Therefore even in the case where the degree of protrusion in the form of a sharp peak or dip in the form of a sharp valley in the characteristics line W of the white shading level is large, making the dust more pronounced, the effect of suppressing the streak in the original image can be maintained.

Also, setting the increase ratio of the correction amount of the black shading level relative to the variation amount of the white shading level when the white shading level rises to be greater corresponds to more promptly increasing the tilt of the characteristics line J in response to the increase in the variation amount of the white shading level (changing the coefficient in the above equation (1)). This is for adjusting the pixel (dust) to be darker to make the streak in the original image less pronounced, since the dust is more pronounced when the white shading level rises than when the white shading level drops.

Note that while in the above embodiments, the light source 91 is turned off and the CCD 95 is caused to perform reading in the main scanning direction in a dark condition to obtain the black shading level, the black shading level may be obtained by causing the CCD 95 to read a reference black plate.

It should be noted that the present invention can be embodied and practiced in other different forms without departing from the spirit or essential characteristics thereof. Therefore, the above-described embodiments are considered in all respects as illustrative and not restrictive. The scope of the invention is indicated by the appended claims rather than by the foregoing description. All variations and modifications falling within the equivalency range of the appended claims are intended to be embraced therein.

What is claimed is:

1. An image reading apparatus comprising:
a photoelectric transducer that performs reading scanning along a main scanning line and reads an original,
the image reading apparatus obtaining a white shading level of pixels based on an output level of the photoelectric transducer obtained when a reference white is read, obtaining a black shading level of the pixels based on an output level of the photoelectric transducer obtained when a black reference is read or obtained in a dark condition, and correcting the output level of the photoelectric transducer obtained when an original image is read with the use of the white shading level and the black shading level, and
the image reading apparatus further comprising a correction unit that obtains a variation amount of the white shading level between a pixel and other pixels in the vicinity of that pixel for each of pixels on the main scanning line, determines whether the variation amount exceeds a pre-set threshold value, and when the correction unit determines that the variation amount exceeds the threshold value, corrects the black shading level of the pixel subject to that determination to increase the black shading level.

2. The image reading apparatus according to claim 1,
wherein when the correction unit determines the variation amount of the white shading level exceeds the threshold value, regardless of whether the white shading level has risen or dropped, the correction unit corrects the black shading level of the pixel subject to that determination to increase the black shading level.

3. The image reading apparatus according to claim 1,
wherein the correction unit increases a correction amount of the black shading level as the variation amount of the white shading level increases.

4. The image reading apparatus according to claim 2,
wherein the correction unit increases a correction amount of the black shading level as the variation amount of the white shading level increases.

5. The image reading apparatus according to claim 3,
wherein the correction unit sets an increase ratio of a correction amount of the black shading level relative to the variation amount of the white shading level to be greater when the white shading level rises so that the variation amount exceeds the threshold value than when the white shading level drops so that the variation amount exceeds the threshold value.

6. The image reading apparatus according to claim 4,
wherein the correction unit sets an increase ratio of a correction amount of the black shading level relative to the variation amount of the white shading level to be greater when the white shading level rises so that the variation amount exceeds the threshold value than when the white shading level drops so that the variation amount exceeds the threshold value.

7. The image reading apparatus according to claim 1,
wherein when pixels for which the correction unit determines that the variation amount of the white shading level exceeds the threshold value are successive pixels, the correction unit counts the number of the successive pixels, and in the case where the number of the successive pixels exceeds a fixed number, the black shading level of the successive pixels is not corrected.

8. An image forming apparatus comprising the image reading apparatus according to claim 1.
